(19) United States
(12) Patent Application Publication
(10) Pub. No.: US 2001/0004286 A1
(43) Pub. Date: Jun. 21, 2001

(54) Paper sheet optical identification method and apparatus

(75) Inventor: Yonezo Furuya, Saitama-ken (JP)

Correspondence Address: KODA & ANDROLIA, Suite 2340, 10100 Santa Monica Boulevard, Los Angeles, CA, 90067, US

(73) Assignee: NIPPON CONLUX CO., LTD.

(21) Appl. No.: 09/737,496

(22) Filed: Dec. 14, 2000

(30) Foreign Application Priority Data
Dec. 14, 1999 (JP) 1999-354949

(51) Int. Cl. G06K 9/74

(52) U.S. Cl. 356/71

(57) ABSTRACT

Disclosed are a method and apparatus which determine the authenticity of a paper sheet with high precision by optically detecting a pattern printed on the paper sheet. A paper sheet optical identification method and apparatus detect optical characteristics of a paper sheet and determine the authenticity of the paper sheet based on the optical characteristics by radiating lights of at least two different wavelengths at a predetermined position on the surface of said paper sheet; detecting at least one of color coefficient, brightness, and chromaticity, of light which has permeated through said paper sheet or light which has been reflected from the surface of said paper sheet; calculating the ratio of at least one of color coefficient, brightness, and chromaticity of said light at each of said wavelengths; and determining the authenticity of said paper sheet according to whether said ratio exceeds a reference.

### BACKGROUND OF THE INVENTION

1. Field of the Invention

The present invention relates to a method and apparatus for determining the authenticity of paper sheets such as money bills and the like. In particular, this invention relates to the method and apparatus which determines the authenticity of a pattern printed on the paper sheet from transmitted and reflected light obtained by radiating light onto the paper sheet.

2. Description of the Related Art

Money bill sorting devices mounted in automatic vending machines check the authenticity of money bills inserted therein before accepting them, and then shift to the vending operation.

Incorrect money bills, such as forgeries and bills brought from abroad, are sometimes inserted into automatic vending machines.

For this reason, automatic vending machines require countermeasures for discharging irregular money bills. The money bills can be checked by using a light source such as visible light or infrared light, and detecting the transmitted light or absorbancy.

However, when a bill has been forged by using a color copying machine or by printing the forgery on a color printer based on data obtained by scanning a genuine bill, checking methods which use visible light or infrared light may mistake such forgeries for genuine bills.

### SUMMARY OF THE INVENTION

The present invention has been realized in consideration of the above points, and aims to provide a method and apparatus capable of authenticating paper sheets with high precision by optically detecting a pattern printed on the paper sheet.

In order to achieve the above objects, this invention provides (1) a paper sheet optical identification method which detects optical characteristics of a paper sheet and determines the authenticity of the paper sheet based on the optical characteristics, comprising the steps of radiating lights of at least two different wavelengths at a predetermined position on the surface of the paper sheet; detecting at least one of color coefficient, brightness, and chromaticity, of light which has permeated through the paper sheet or light which has been reflected from the surface thereof; calculating the ratio of at least one of color coefficient, brightness, and chromaticity of the light at each wavelength; and determining the authenticity of the paper sheet according to whether the ratio exceeds a reference; and

a paper sheet optical identification apparatus comprising a light source which generates lights of at least two different wavelengths; a detecting unit which detects at least one of color coefficient, brightness, and chromaticity, of light which has been radiated from the light source and permeated through the paper sheet or light which has been reflected from the surface of the paper sheet; a calculating unit which calculates the ratio of at least one of color coefficient, brightness, and chromaticity of the light at each of the wavelengths; and a comparing unit which determines the authenticity of the paper sheet by comparing the ratio calculated by the calculating unit with a reference.

### BRIEF DESCRIPTION OF THE DRAWINGS

FIG. 1 is a diagram showing the constitution of an apparatus in an embodiment of this invention;

FIG. 2 is a block line diagram showing a signal processor which processes signals from the elements in FIG. 1;

FIG. 3 is a diagram showing a simplified view of a pattern on a US one dollar bill as an example of a bill to be checked by the apparatus shown in FIGS. 1 and 2;

FIG. 4 is a diagram showing characteristics of pattern data of transmitted light, obtained by optically scanning a money bill X approximately in its center in the lengthwise direction;

FIG. 5 is a characteristics diagram of data which have been trimmed and is represented as three-color coefficients;

FIG. 6 is a characteristics diagram showing transmission factors of three colors R, G, and B, in trimmed data which have been extracted from the basic data shown in FIG. 4;

FIG. 7 is a characteristics diagram showing the sum of the transmission factors of each of the colors shown in FIG. 6 as a total of three colors;

FIG. 8 is a characteristics diagram showing chromaticity which has been determined based on the three-color coefficients shown in FIG. 5, that is, the hues and chroma in the three color elements.

FIG. 9 is a characteristics diagram showing running average results determined from the chromaticity changes shown in FIG. 8.

FIG. 10 is a diagram summarizing the principles of this invention in a flowchart;

FIG. 11 is a main flowchart of data processing executed by the microprocessor MPU in FIG. 2;

FIG. 12 is a main flowchart of data processing executed by the microprocessor MPU in FIG. 2;

FIG. 13 is a main flowchart of data processing executed by the microprocessor MPU in FIG. 2;

FIG. 14 is a flowchart showing a process for adjusting the intensity of light emitted by a light-emitting diode;

FIG. 15 is a flowchart showing contents of processes of extracting data from a detecting sensor S2 by interrupt, and calculating the total brightness and chromaticity;

FIG. 16 is a flowchart showing contents of processes of extracting data from a detecting sensor S2 by interrupt, and calculating the total brightness and chromaticity;

FIG. 17 is a flowchart showing steps of calculating a correlation coefficient which are executed subsequent to calculating the transmission factor;

FIG. 18 is a flowchart showing steps of calculating a correlation coefficient which are executed subsequent to calculating the transmission factor; and

FIG. 19 is a diagram using coordinates to show the relationship between the brightness and chromaticity described above.

### PREFERRED EMBODIMENTS

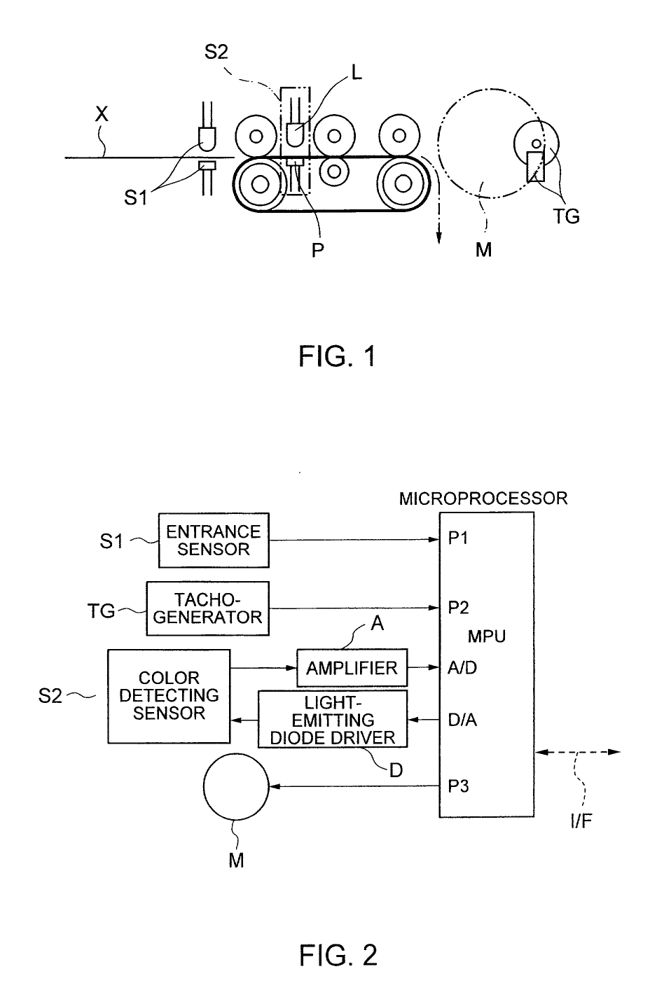

FIG. 1 is a diagram showing the constitution of an apparatus according to an embodiment of this invention. In FIG. 1, a carrying mechanism carries a money bill X from the left to the right of the diagram. An entrance sensor S1 is provided at the left side of the carrying mechanism, and optically detects whether a paper sheet comprising the money bill X has been inserted.

When the entrance sensor S1 detects the money bill X, a control device (not shown in the diagram) forwardly rotates a carrying motor M, driving elements such as pulleys and belts which are linked to the carrying motor M and leading the money bill into the apparatus. When the front tip of the money bill X reaches a color detecting sensor S2, the color detecting sensor S2 detects light which has passed through the money bill X.

The color detecting sensor S2 comprises a light-emitting diode L which emits at least two colors of light, and a photodiode P which detects the light which has been emitted by the light-emitting diode L and has passed through the money bill X. The color detecting sensor S2 detects the transmitted light of each color and sends a detection signal to a signal processor (not shown in the diagram). The light-emitting diode L has a single-unit constitution and can emit lights of multiple wavelengths.

While the money bill X is being carried, a tacho-generator TG detects the rotation of the carrying motor M and transmits a detection signal corresponding to the amount of rotation to the signal processor.

FIG. 2 shows the signal processor which processes signals from the elements in FIG. 1. A microprocessor is used as the signal processor, and the detection signals from the entrance sensor S1 and the tacho-generator TG are supplied to ports P1 and P2 of the microprocessor MPU.

A light-emission signal is supplied from the port D/A of the microprocessor MPU via a light-emitting diode driver D to the color detecting sensor S2. Based on this signal, the color-light-emitting diodes in the color detecting sensor S2 are illuminated. Light which has been transmitted through the money bill X is detected by a light-receiving element in the color detecting sensor S2, and is sent via an amplifier A to the port A/D of the microprocessor MPU.

In addition to processing the above signals, the microprocessor MPU feeds power from a port P3 to the carrying motor M and thereby controls the carrying of the money bill X. Furthermore, the microprocessor MPU transmits the processed signals via an interface I/F to an outside circuit, and receives various types of command signals and the like from the outside circuit.

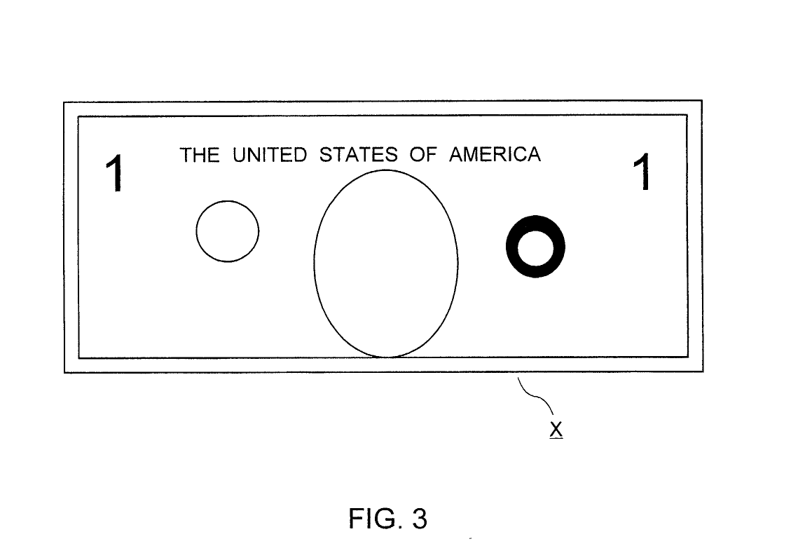

FIG. 3 is a simplified representation of a pattern on a US one dollar bill as an example of a money bill which is checked by the apparatus shown in FIGS. 1 and 2. Normally, in checking a money bill, the money bill is for example scanned in one direction, and the authenticity of the bill is determined by comparing the detected signal with a reference signal. In the case shown in FIG. 3, the central portion of the lengthwise direction of the bill is scanned in the lengthwise direction to obtain pattern data.

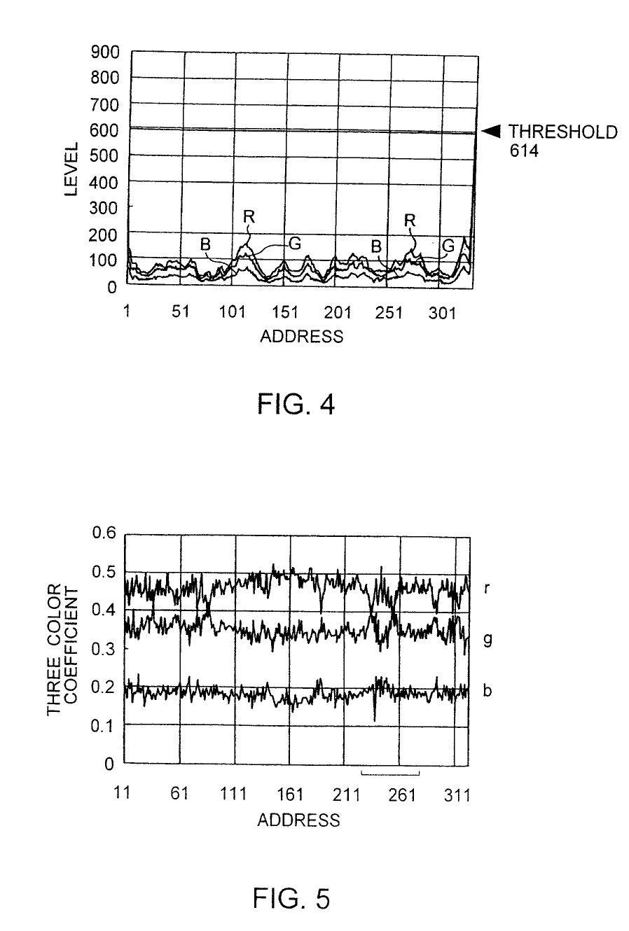

FIG. 4 shows pattern data of transmitted light, obtained by optically scanning the approximately central portion of the money bill X shown in FIG. 3 in the lengthwise direction. For example, three hundred and thirty-three addresses are allocated from one end of the money bill X to the other in its lengthwise direction, and the three-color transmitted light levels at each address are expressed in nine hundred stages. The three-color lights comprise red R, green G, and blue B light. The lights change in the same way, but the level of light passing through the money bill X naturally differs in accordance with the printed pattern.

The regions at both ends of the money bill X, i.e. the regions near address 1 and address 333, have abnormal values which far exceed the threshold (614). For this reason, the end regions are excluded from the check, and the signal is processed only after the data has been trimmed by deleting the end portions.

FIG. 5 shows three-color coefficients of the trimmed data. As is well known, three color coefficients express the ratio of each color. Expressing the colors as r, g, and b, this can be written as

r=R/S, g=G/S, b=B/S

S=R+G+B

Here, r, g, and b are the three-color coefficients.

Of the three-color coefficients r, g, and b in FIG. 5, b changes the least overall, g changes by a moderate degree, and r has the greatest change. However, there is a reversal between r and g in the portion between addresses 220 to 260, g becoming higher and r dropping to the moderate level. This is the portion where the US Finance Department stamp is printed in green ink as a unique feature on the surface of the bill. As a result, the data of the transmitted light for this portion has different characteristics from the other portions. Therefore, the authenticity of the bill can be determined by checking whether this unique feature appears correctly.

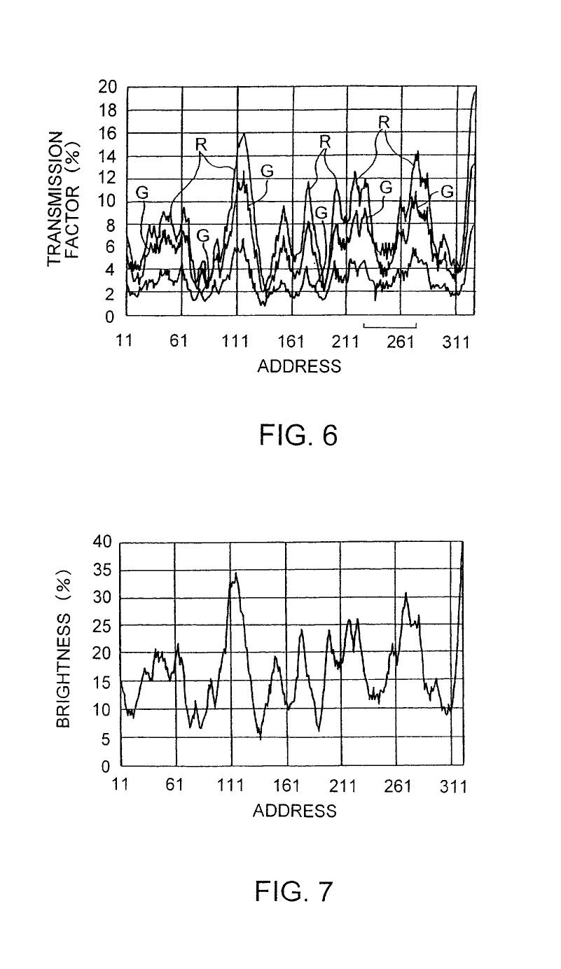

FIG. 6 shows transmission factors of each of the colors R, G, and B in trimmed data which have been extracted from the basic data shown in FIG. 4. The transmission factors differ according to the density of the ink in the pattern printed on the bill, and change greatly depending on the address.

The transmission factor T(λ) at a specific wavelength λ can be determined by

T(λ)={Di(λ)/Ref(λ)}×100[%]

where Di (λ) is the value at each address of the wavelength, and Ref(λ) is the standby value for that wavelength.

FIG. 7 shows the sum of the transmission factors of each of the colors shown in FIG. 6, obtaining by calculating the total of the three colors. The sum expresses “brightness” which is not included in the “chromaticity” in the three elements of color. Considering Grassman's law that “the brightness of a color obtained by mixing is the sum of the brightness of the original colors”, it can be said that the brightness of a color obtained by mixing is the sum of the transmitted lights in the colors. It is assumed here that the transmitted light, obtained when light from the color light sources R, G, and B passed through the money bill, comprises a mixture of three colors.

Therefore, it is possible to evaluate the density of the ink printed on the bill by using the sum of the transmitted light. As shown in FIG. 7, the brightness can be treated as a brightness pattern for the addresses.

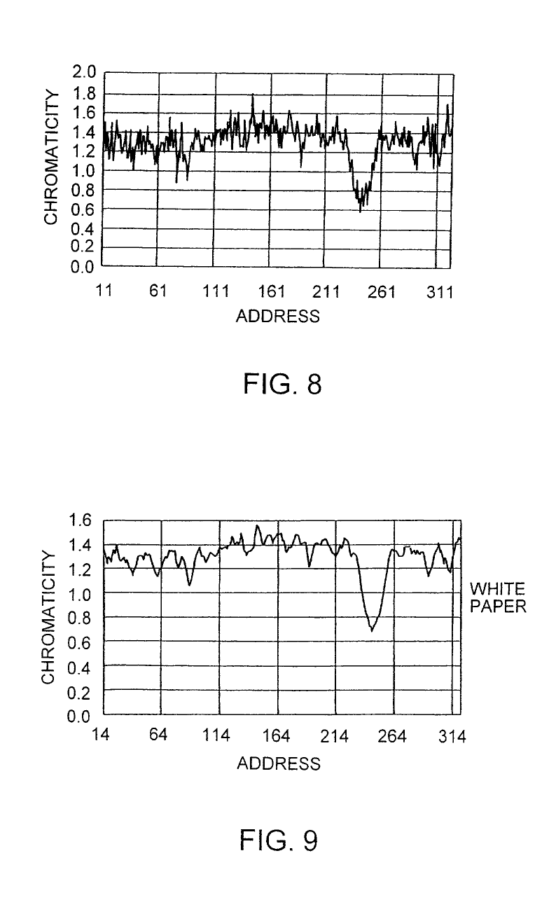

FIG. 8 shows chromaticity which has been determined based on the three-color coefficients shown in FIG. 5, that is, the hues and chroma in the three color elements. Chromaticity is another useful indicator, in addition to brightness, for expressing the transmission factor of each color.

To determine the chromaticity F, the total T(S) of the transmission factors of the colors R, G, and B is defined as

T(S)=T(R)+T(G)+T(B)

Color coefficients r(T) and g(T) are determined from the color transmission factors T(R), T(G), and T(B) by

r(T)=T(R)/T(S)

g(T)=T(G)/T(S)

and the chromaticity F is determined by using the color coefficients r(T) and g(T) as follows

F=r(T)/g(T)

The color coefficient b(T) is

b(T)=T(B)/T(S)

FIG. 8 shows the chromaticity F which is determined in this way. As shown in FIG. 8, the chromaticity F decreases considerably near addresses 220 to 260. This corresponds to the portion where the US Finance Department stamp is printed in green ink as shown in FIG. 5.

FIG. 9 shows running average results determined from the chromaticity changes shown in FIG. 8 when the gap between addresses is set to 5. FIG. 9 eliminates the very small changes in chromaticity which appear in FIG. 8, and shows the average change.

Since this invention uses multiple lights, the relationship between the color of the light sources and the color of the money bill must be investigated. Table 1 below shows the correlation between the transmission factors of the colors, and Table 2 shows results of an investigation of the correlation between the transmission factors of the colors (using a US dollar bill).

Table 1

Red Transmission factor

Green Transmission factor

Blue Transmission factor

As shown in Table 1, the correlation coefficients of the colors R, G, and B are greater than 0.9. This extremely high value shows that it is possible to detect the density of the ink printed on the bill by using the transmission factor, irrespective of the color of the light source.

Table 2

r(T)=T(R)/T(S)

g(T)=T(G)/T(S)

b(T)=T(B)/T(S)

As shown in Table 2, the correlation coefficients of the three-color coefficients have negative values between r(T) and g(T). This indicates a negative relationship between the reaction of the red light source to the color of the ink on the bill and the reaction of the green light source. This causes the reversal of r and g between addresses 220 and 260 in FIG. 5. The correlation coefficients between r(T) and b (T), and g(T) and b(T), are comparatively small. Thus, it is possible to detect the color of ink printed on the bill by using the three-color coefficients or chromaticity determined from the three-color coefficients.

The facts shown in Tables 1 and 2 are evidence that phenomena occurring when using the transmission factors are different from those when using the three-color coefficients.

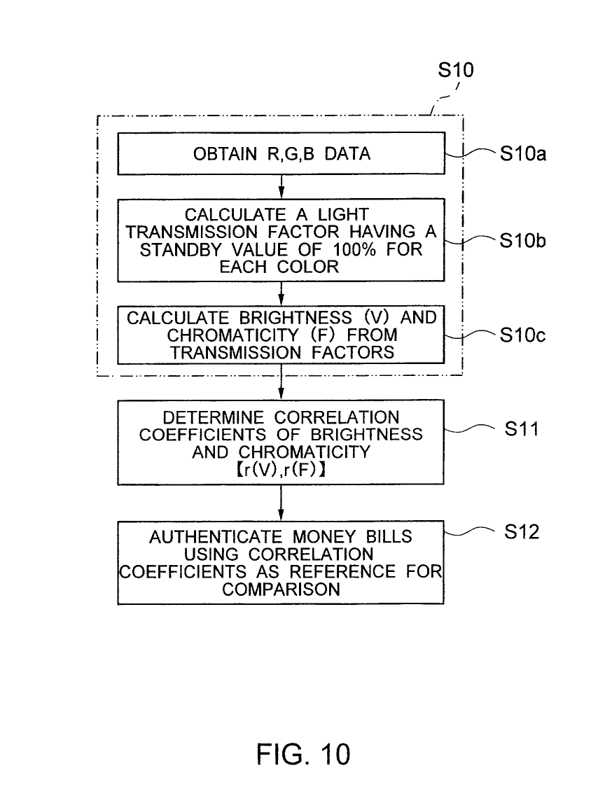

FIG. 10 summarizes the principles of this invention in a flowchart. The process S10 executed at each address comprises steps S10a to S10c.

Firstly, data of three colors R, G, and B is obtained from light which passes through the money bill when light of more than two colors is radiated thereon (S10a), and a light transmission factor having a standby value of 100% is calculated for each color data (S10b). Brightness V is determined based on the transmission factor, or alternatively, the three-color coefficients r, g, and b are calculated from the transmission factors and chromaticity F is determined based on the three-color coefficients (S10c). Subsequently, the correlation coefficients of the brightness V or the chromaticity F are determined (S11), and the money bill is authenticated by using these correlation coefficients as references for comparison (S12).

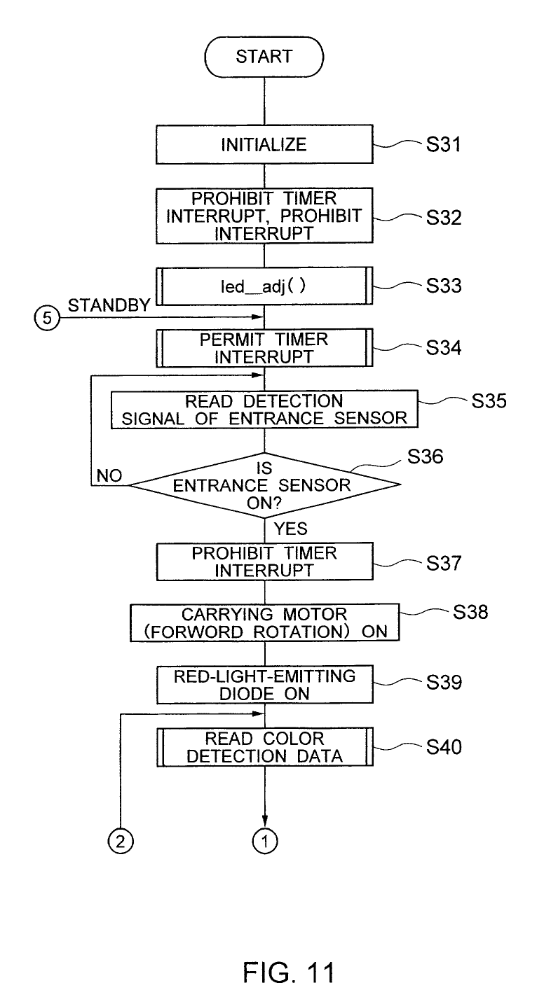

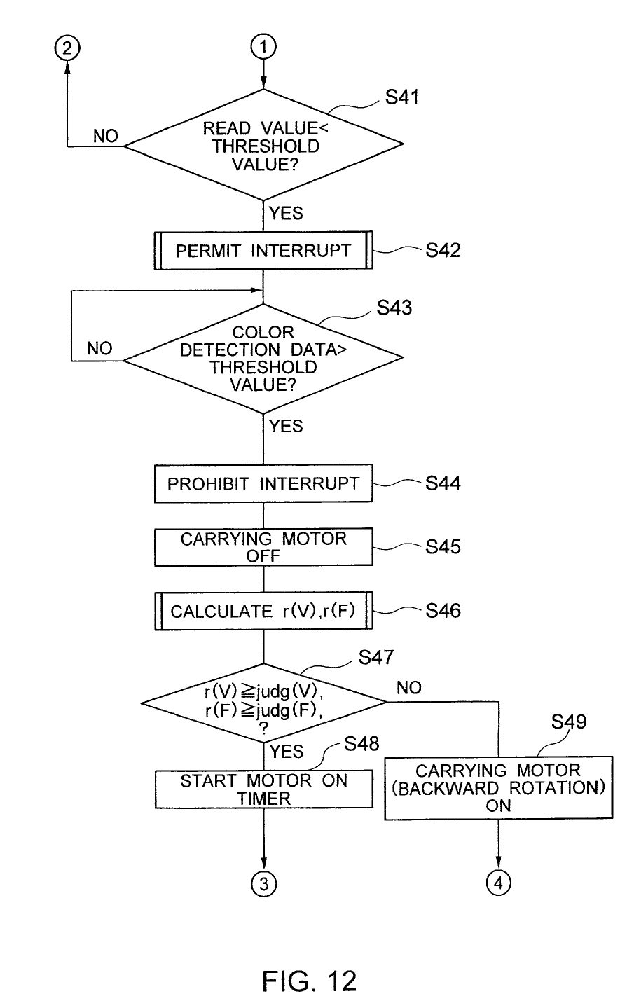

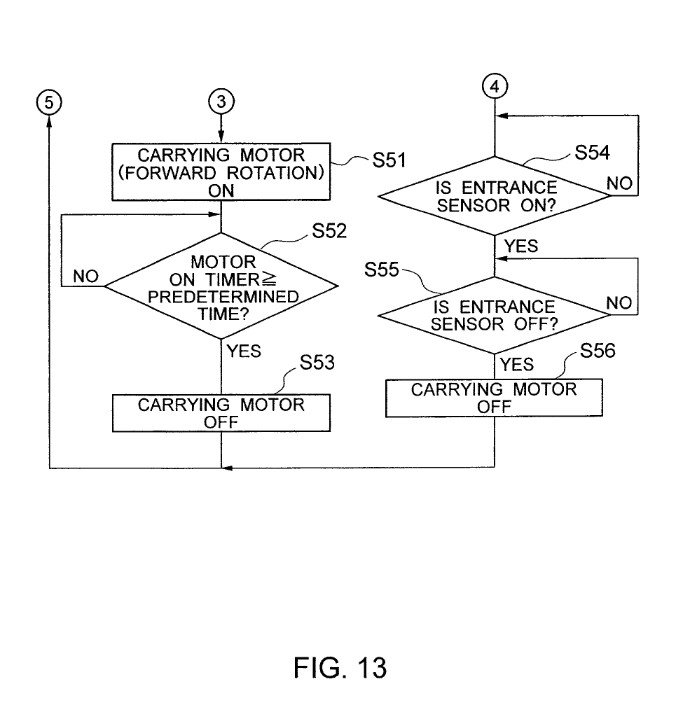

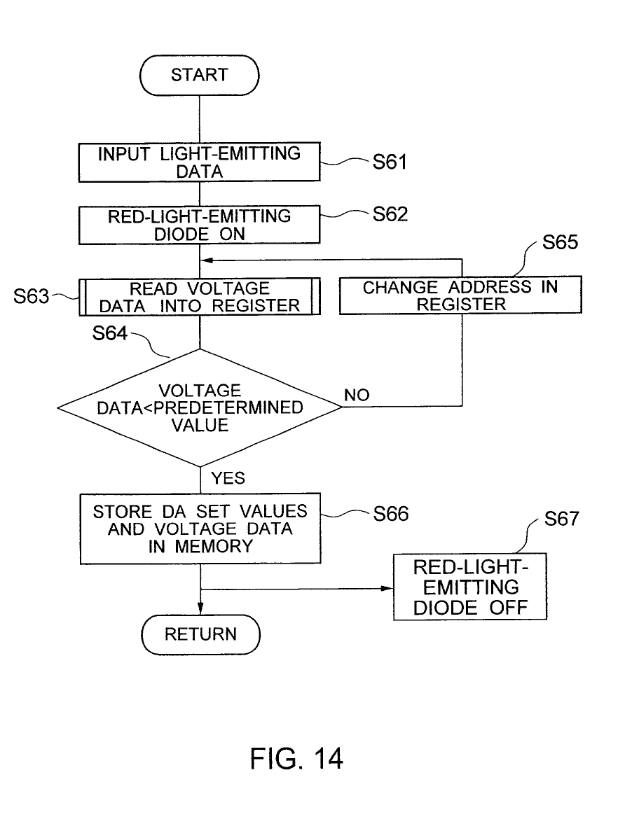

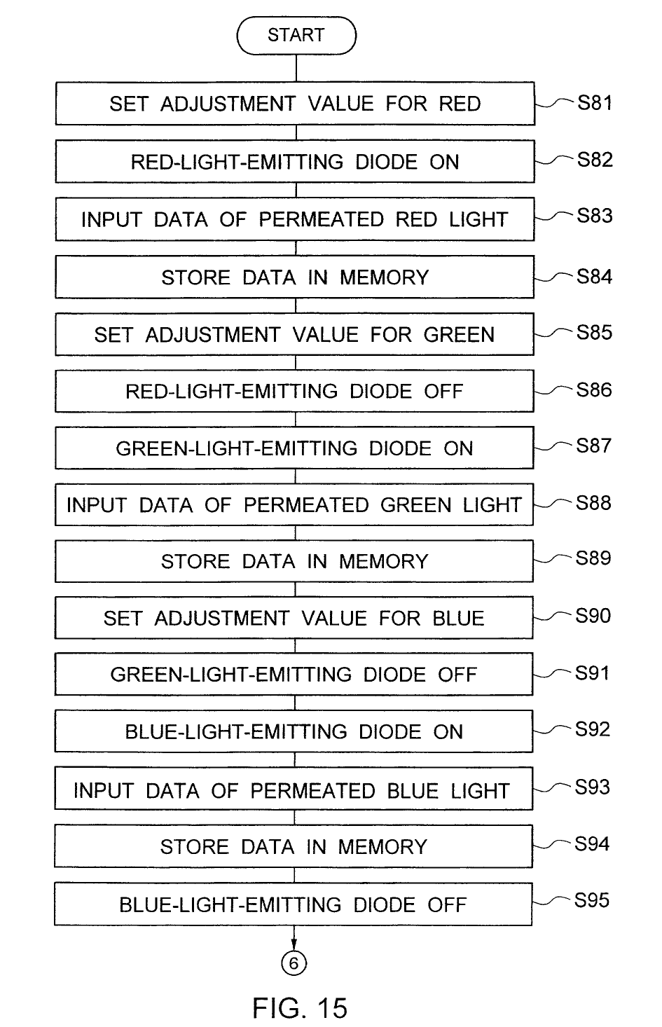

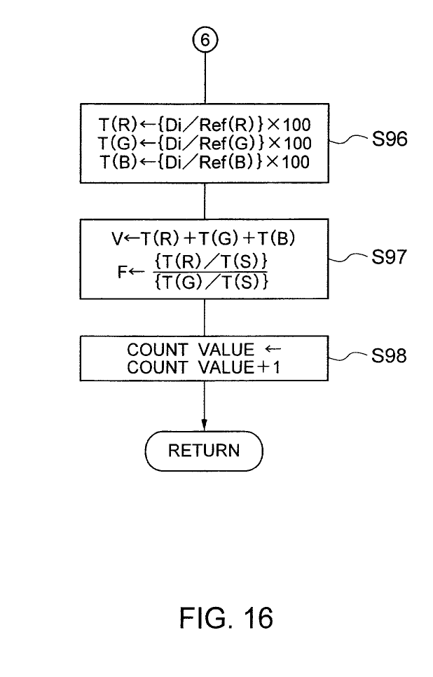

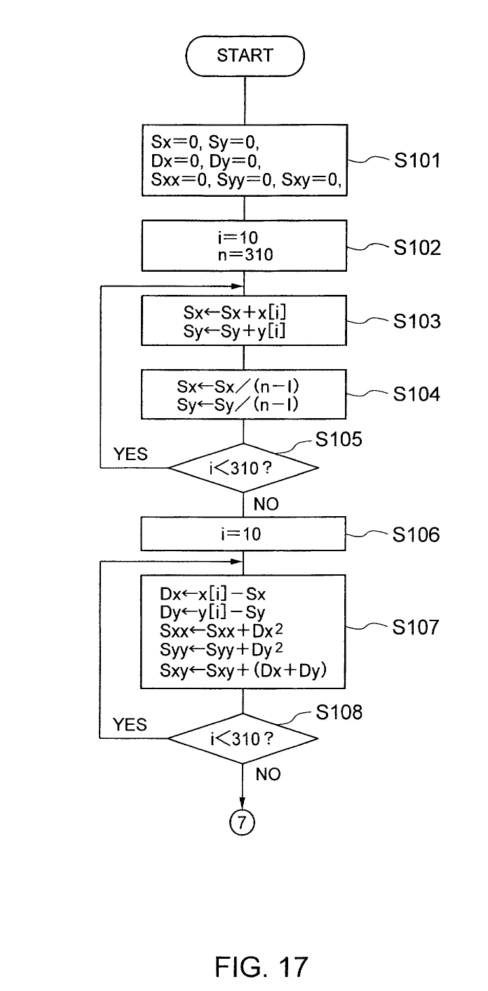

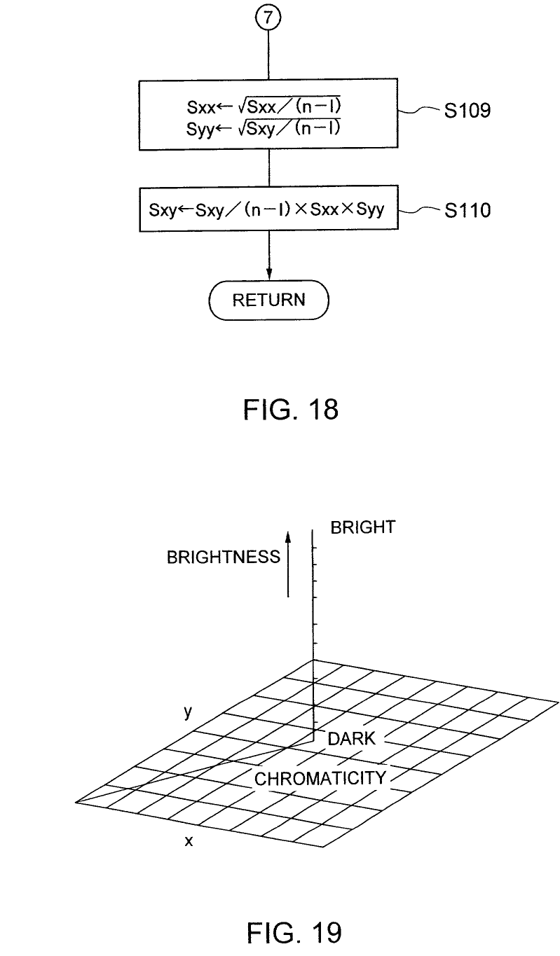

FIGS. 11 to 20 show contents of data processing executed by the microprocessor MPU in FIG. 2. FIGS. 11 to 13 show the main flow, FIG. 14 shows a process of adjusting the intensity of light emitted by the light-emitting diode, FIGS. 15 and 16 show an interrupt process, and FIGS. 17 and 18 show a process of calculating the correlation coefficients.

In FIG. 11, at the start-up of the apparatus, the register and other sections are initialized in step S31. In step S32, a timer interrupt prohibit and an interrupt prohibit are issued. Then, the standby voltage is read in step S33. The standby light-receiving voltage of each color light source is read, and the standby voltage of each color light source is adjusted.

In step S34, permission is given for a timer interrupt. Processing shifts to step S35, in which the detection signal of the entrance sensor S1 (FIG. 1) is read into the port P1. Processing then shifts to step S36, in which it is determined whether or not the entrance sensor is ON. When the entrance sensor is ON, processing shifts to step S37; when the sensor is not ON, processing returns to step S35.

In step S37, since the entrance sensor was ON in step S36, the timer interrupt is prohibited. The forward rotation of the carrying motor delivers the money bill inside the apparatus (S38) and the red-light-emitting diode illuminates (S39).

The AD port of the microprocessor MPU reads the color detection data from the color detecting sensor S2 (S40), and the microprocessor MPU determines whether the read value is below the threshold, i.e. whether the money bill has reached the position of the color detecting sensor (S41). When the money bill has not yet reached that position, processing returns to step S40 and the color detection data is read. When the money bill has reached the position of the color detecting sensor, processing shifts to step S42 in which permission is given to interrupt. Proceeding to step S43, data is extracted until the value of the color detection data exceeds the threshold, at which point processing shifts to step S44, in which interrupt is prohibited. In step S45, the carrying motor is switched OFF and the money bill is held stationary while the data processes from step S46 onwards are carried out.

In step S46, the correlation coefficient r(V) for brightness and the correlation coefficient r(F) for chromaticity are calculated based on the data detected by the color detecting sensors. In step S47, it is determined whether the correlation coefficients r(V) and r(F) calculated in step S46 are greater than references judg(V) and judg(F).

When it is determined in step S47 that the correlation coefficients exceed the references, processing shifts to step S48 in which the carrying motor is rotated forward (S51) and the money bill is delivered into the apparatus. The timer is operated for a predetermined period of time (S52) and the carrying motor is switched OFF in step S53.

On the other hand, when it is determined in step S47 that the correlation coefficients do not exceed the references, the carrying motor is rotated backward in step S49 and processing shifts to step S54. After it has been confirmed that the entrance sensor is ON, the delivery of the money bill ends in step S55. After it has been confirmed that the entrance sensor is OFF, the carrying motor is switched OFF (S56) and processing returns to step S40.

FIG. 14 shows a process of adjusting the intensity of light emitted by the light-emitting diode. In step S61, the light-emitting data with the MAX value is input to a DA register, and the light-emitting diode is illuminated (S62). In step S63, the microprocessor MPU reads the voltage of the photodiode P and, in step S64, determines whether the voltage is below a predetermined value. When voltage > predetermined value, processing returns to step S63 after changing one address in the register in step S65.

The operations of steps S63, S64, and S65, are repeated until voltage < predetermined value, at which point processing shifts to step S66. Instep S66, the set values of the color light sources in the DA register are stored in the memory. In addition, the voltage of the light-receiving element is stored in the memory.

This example describes the process of adjusting red (R), but the process is the same when adjusting green (G) and blue (B).

FIGS. 15 and 16 are flowcharts showing processes of generating an interrupt in synchronism with the tacho-generator TG, reading the voltage obtained from the photodiode P for each color light source, and calculating the brightness and chromaticity. Firstly, the data for red R is extracted in steps S81 to S84. Then, the data for green G is extracted in steps S85 to S89. Finally, the data for blue B is extracted by the same method in steps S90 to S94. The case of red R will be explained by way of example.

The adjustment value of the register is set in step S81 in order to ignite the light-emitting diode. The light-emitting diode is illuminated in step S82. In step S83, data of the permeated red R light which has been received by the light-receiving element is input to the register. In step S84, the AD converted data is stored in the memory.

Data of the three colors is extracted in this way, and the transmission factors are calculated in step S96 based on the extracted data. In the case of red R, the transmission factor T(R) is the ratio Di/Ref(R) of the received light data to the reference Ref(R). The calculations for green G and blue B are the same.

In step S97, the brightness V and chromaticity F are calculated by using the transmission factors T(R), T(G), and T(B). Since the brightness V is the sum of the transmission factors, it is calculated by

V=T(R)+T(G)+T(B)

The chromaticity F is the proportion of the sum T(S) of the transmission factors accounted for by the transmission factor of each color, expressed as ratio between the three different colors, and is determined by

F={T(R)/T(S)}/{T(G)/T(S)}=T(R)/T(G)

This is calculated at each address while incrementing the counter (S96).

FIG. 17 shows steps of calculating the correlation coefficient subsequent to calculating the transmission factors. In step S101, the process is initialized by making the register values (e.g. standard deviations Sx, Sy, detection values Dx, Dy of the addresses, etc.) zero.

In step S102 the data is trimmed. That is, only data up to address (i)10 is kept, and the portion beyond 310 is excluded from the processing. In step S103, sum totals of standard deviation Sx and Sy are calculated by

Sx+x[i]

Sy+y[i]

and are stored in the register. In step S104, the following calculation is made to determine average values

Sx/(n−1)

Sy/(n−1)

In step S105, it is determined whether address 310 has been reached, the processes of steps S103 and S104 being repeated until then. When the address 310 has been reached, the address is set to 10 in step S106 and processing shifts to step S107, in which dispersion S2 is calculated. The dispersion S2 is a quantity showing how widely n number of values around the average have been scattered.

Based on the calculation of step S107, it is determined in step S108 whether the address is less than 310. The calculation is repeated for each address until address 310 is reached. That is, the calculation of step S107 is as follows

Dx←x[i]−Sx

Dy←y[i]−Sy

Sxx←Sxx+Dx²

Syy←Syy+Dy²

Sxy←Sxy+(Dx+Dy)

When the dispersion S2 up to address 310 has been calculated, standard deviations Sxx and Syy are calculated in step S109.

The calculation performed in step S109 shown in FIG. 18 is as follows

Sxx←√{Sxx /(n−1)}

Syy←√V{Sxy /(n−1)}

Subsequently, the correlation coefficient Sxy is calculated in step S110 as follows

Sxy←Sxy /(n−1)}×Sxx×Syy

Thereafter, the processing returns to the main flow.

FIG. 19 uses coordinates to show the relationship between brightness and chromaticity described above. As shown in FIG. 19, when chromaticity is represented by the horizontal plane X-Y, the brightness is represented as a component along an axis perpendicular thereto.

The above explanation describes a money bill as an example of a paper sheet, but this invention can also be applied to securities certificates and coupons.

The embodiment described above detects transmission factors of the light, but absorbancy in the surface of the paper sheet or light reflected from the surface may be detected instead.

The time taken to carry out the calculations in the above embodiment can be reduced by pre-calculating the values which can be calculated in advance and storing them in memory.

As described above, to detect a pattern printed on a paper sheet, lights of at least two wavelengths are radiated onto the surface of the paper sheet to obtain transmitted light and reflected light. The brightness and chromaticity at each wavelength are detected and the ratio between them is determined. The authenticity of the paper sheet is determined according to whether this ratio has exceeded a reference. Therefore, it is even possible to correctly identify skilful forgeries which have been made by using a color copying machine or a color printer.

What is claimed is:

1. A paper sheet optical identification method which detects optical characteristics of a paper sheet and determines the authenticity of the paper sheet based on the optical characteristics, comprising the steps of
radiating lights of at least two different wavelengths at a predetermined position on the surface of said paper sheet;
detecting at least one of color coefficient, brightness, and chromaticity, of light which has permeated through said paper sheet or light which has been reflected from the surface of said paper sheet;
calculating the ratio of at least one of color coefficient, brightness, and chromaticity of said light at each of said wavelengths; and
determining the authenticity of said paper sheet according to whether said ratio exceeds a reference.

2. A paper sheet optical identification apparatus comprising:
a light source which generates lights of at least two different wavelengths;
a detecting unit which detects at least one of color coefficient, brightness, and chromaticity, of light which has been radiated from said light source and permeated through said paper sheet or light which has been reflected from the surface of said paper sheet;
a calculating unit which calculates the ratio of at least one of color coefficient, brightness, and chromaticity of said light at each of said wavelengths; and
a comparing unit which determines the authenticity of said paper sheet by comparing the ratio calculated by said calculating unit with a reference.

3. The paper sheet optical identification apparatus as described in claim 2, said light source generating lights of at least two wavelengths from among the following: red, green, and blue.

4. The paper sheet optical identification apparatus as described in claim 2, said light source comprising a single-unit which generates lights of a plurality of different wavelengths.

5. The paper sheet optical identification apparatus as described in claim 2,
said detecting unit detecting both brightness and chromaticity;
said calculating unit calculating correlation coefficients between brightness and chromaticity in the detected signals; and
said comparing unit comparing said correlation coefficients with a predetermined reference for correlation coefficient.

6. The paper sheet optical identification apparatus as described in claim 5, said calculating unit determining a standard deviation for determining said correlation coefficient prior to calculating said correlation coefficient.

7. The paper sheet optical identification apparatus as described in claim 2, said calculating unit processing a running average of signals detected by said detecting unit.
